(19) United States
(12) Patent Application Publication
(10) Pub. No.: US 2009/0213145 A1
(43) Pub. Date: Aug. 27, 2009

(54) DISPLAY DEVICE AND METHOD FOR ADJUSTING COLOR TONE OR HUE OF IMAGE

(75) Inventor: Masashi Onizawa, Oume-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/210,907

(22) Filed: Sep. 15, 2008

(30) Foreign Application Priority Data
Feb. 27, 2008 (JP) 2008-046209

(51) Int. Cl. G09G 5/10; G09G 3/32

(52) U.S. Cl. 345/690; 345/88

(57) ABSTRACT

A display device includes an image data receiving unit receiving image data, a liquid crystal display unit displaying an image based on the image data received by the image data receiving unit, a light source supplying light to the liquid crystal display unit, an input unit inputting information showing a use environment at a time of viewing an image displayed on the liquid crystal display unit, a luminance value calculating unit calculating a value for adjusting a color tone or hue of the light source or the image based on the inputted information, and a color adjusting unit adjusting the color tone or hue of the light source or the image based on the calculated value.

### CROSS-REFERENCE TO RELATED APPLICATIONS

This application is based upon and claims the benefit of priority from the prior Japanese Patent Application No. 2008-46209, filed on Feb. 27, 2008; the entire contents of which are incorporated herein by reference.

### BACKGROUND OF THE INVENTION

1. Field of the Invention

The present invention relates to a display device and a method for adjusting a color tone or hue of an image.

2. Description of the Related Art

Conventionally, the art of changing the contrast and brightness of an image displayed on a display device in accordance with the brightness of a room is disclosed (for example, see JP-A 11-112908(KOKAI)). Incidentally, an image displayed on a display device is sometimes perceived in a color different from the original color depending on the color or the like of the illumination of the room. For example, when the color of the illumination of a room is tinged with red, the color of the image tends to look bluer than the original color to the viewer.

### BRIEF SUMMARY OF THE INVENTION

The present invention has an object to provide a display device and a method for adjusting a color tone or hue of an image which are capable of easily adjusting a color tone or hue of an image in accordance with the use environment of the display device when the image is viewed.

A display device of the present invention includes an image data receiving unit receiving image data, a display unit displaying an image based on the image data received by the image data receiving unit, a light source supplying light to the display unit, an input unit inputting information showing a use environment at a time of viewing an image displayed on the display unit, a luminance value calculating unit calculating a value for adjusting a color tone or hue of the light source or the image based on the inputted information, and a color adjusting unit adjusting the color tone or hue of the light source or the image based on the calculated value.

A method for adjusting a color and hue of an image of the present invention is a method for adjusting a color tone or hue of an image in a display device including a display unit displaying the image and a light source supplying light to the display unit, and includes inputting information showing a use environment at a time of viewing an image displayed on the display unit, calculating a value indicating a color tone or hue of the light source or the image based on the inputted information, receiving the image data, adjusting the color tone or hue of the light source or the image based on the calculated value, and displaying an image based on the received image data.

### BRIEF DESCRIPTION OF THE DRAWINGS

FIG. 1 is a block diagram showing a configuration of a liquid crystal display device 1 according to a first embodiment.

FIGS. 2A to 2C are conceptual diagrams showing Tables T1 to T3 which are stored by a memory unit 65 included by the liquid crystal display device 1.

FIG. 3 is a chromaticity diagram.

FIG. 4 is a conceptual diagram showing a setting menu displayed on a display unit 20.

FIG. 5 is a flowchart showing a method for adjusting a color tone or hue of an image.

FIG. 6 is a block diagram showing a liquid crystal display device 2 according to a second embodiment.

### DETAILED DESCRIPTION OF THE INVENTION

### First Embodiment

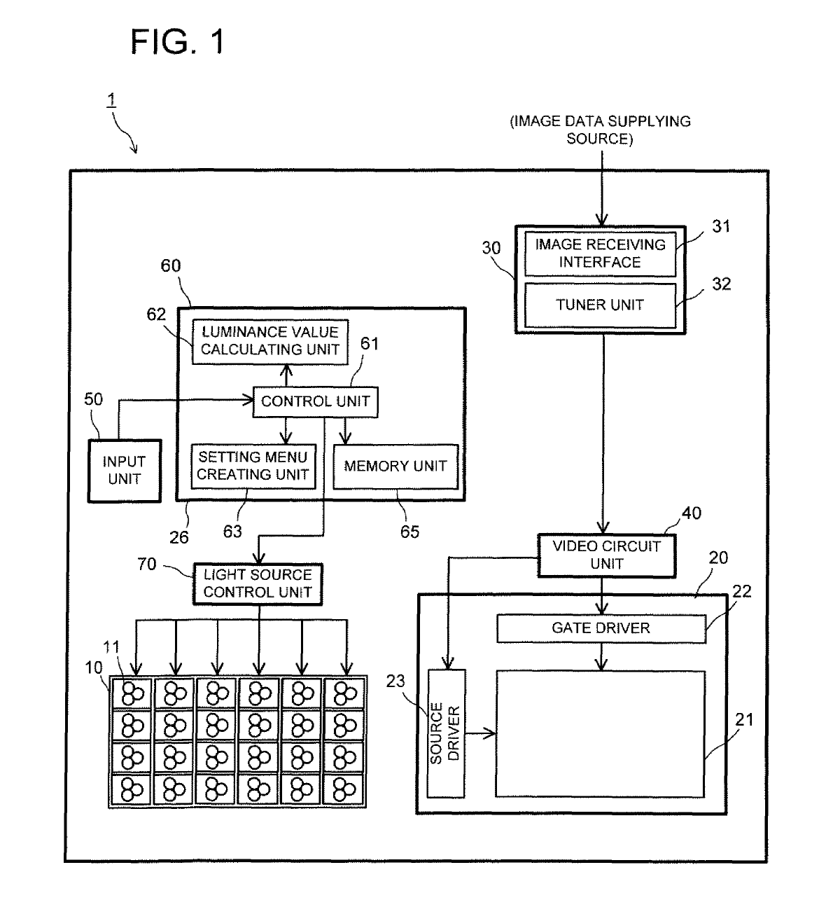

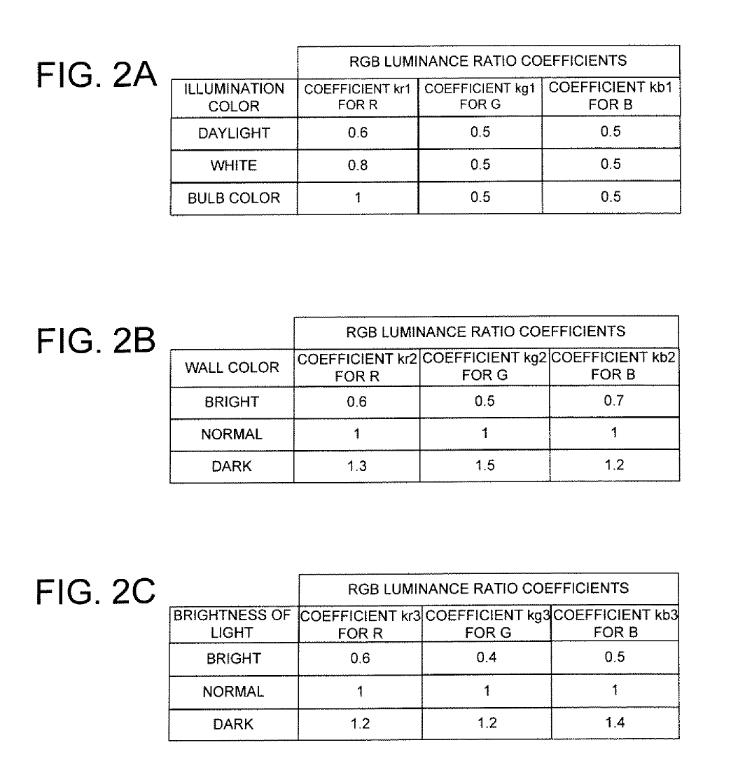

Hereinafter, a liquid crystal display device 1 according to a first embodiment of the present invention sill be described in detail with reference to the drawings. FIG. 1 is a block diagram showing the configuration of the liquid crystal display device 1. FIGS. 2A to 2C are conceptual diagrams respectively showing Tables T1 to T3 stored by a memory unit 65 included by the liquid crystal display device 1. The liquid crystal display device 1 includes a backlight unit 10, a display unit 20, an image data receiving unit 30, a video circuit unit 40, an input unit 50, a color adjusting unit 60 and a light source control unit 70.

The backlight unit 10 has a plurality flight source units 11, and supplies light to the display unit 20. The backlight unit 10 is disposed in the display unit 20, particularly on a back side of a liquid crystal panel 21 which will be described later. A pair of diffusion plates and a prism sheet sandwiched by the diffusion plates are provided between the backlight unit 10 and the liquid crystal panel 21, though not illustrated. The diffusion plates scatter and diffuse the light of the light source unit 11 to prevent occurrence of nonuniformity in the brightness of the light which is supplied to the display unit 20.

The prism sheet is for enhancing the luminance of the light which is supplied from the light source unit 11.

The light source unit 11 is disposed in a matrix form, and is controlled by the light source control unit 70 to emit light. The light source unit 11 has a plurality of LEDs (Light Emitting Diodes) of luminescent colors differing from one another (for example, three primary colors of red (R), green (G) and blue (B)). By mixing the lights from the LEDS of RGB, white light is obtained. Further, by controlling the luminance ratio of RGB, the color temperature in each of the light source units 11 can be changed. For example, when the red LED is caused to emit light with strong luminance, and the LEDs of the other colors are caused to emit light with weak luminance, the color temperature becomes low. Further, when the blue LED is caused to emit light with strong luminance and the LEDs of the other colors are caused to emit light with weak luminance, the color temperature becomes high. By changing the color temperature in each of the light source units 11, coloration (hue) and vividness of the color and brightness of the color (color tone) as the entire backlight unit 10 can be controlled.

For the light source unit 11, various kinds of light emitting elements can be used without being limited to LEDs. As the light emitting elements, for example, organic EL (Electro Luminescence), inorganic EL, and a laser diode (Laser Diode) are cited. Further, the light source unit 11 is not limited to the one that supplies the light of three primary colors, but may be the one that supplies light of a plurality of colors.

The display unit 20 is mainly configured by the liquid crystal panel 21, a gate driver 22 and a source driver 23.

The liquid crystal panel 21 is configured by holding a liquid crystal material between two sheets of glass in which scanning lines and data lines are disposed respectively, though not specially illustrated. The scanning lines and the data lines intersect each other, and are driven by the gate driver 22 and the source driver 23. The spots where the scanning lines and the data lines intersect one another correspond to pixels. By applying a voltage to the scanning lines and data lines, R, G and B are developed in each of the pixels, and a color image is displayed on the liquid crystal panel 21. By controlling the magnitude of the voltage which is applied to the scanning lines and the data lines, the color tone and the like of R, G and B in each of the pixels can be controlled.

The gate driver 22 sequentially outputs a voltage waveform in a pulse shape to the scanning lines. The source driver 23 outputs a voltage waveform in a pulse shape to the signal lines in response to the output of the voltage waveform in the pulse shape from the gate driver 22.

The image data receiving unit 30 receives various kinds of video signals (image data) from an outside of the liquid crystal display device 1, and outputs the received image data to the video circuit unit 40. The image data receiving unit 30 includes an image receiving interface 31 and a tuner unit 32.

The image receiving interface 31 includes, for example, an HDMI (High-Definition Multimedia Interface) terminal, a component terminal, a composite terminal and the like, and connects external connection devices (for example, a DVD player, a DVD recorder, PC) and the like to the liquid crystal device 1. Image data is inputted into the image receiving interface 31 from the external connection devices.

The tuner unit 32 is connected to an antenna and the like not illustrated, and receives various kinds of image data on terrestrial analog waves, terrestrial digital waves, satellite broadcasting radio waves and the like.

“Image data” is configured by image data of, for example, R, G and B. The image data of R, G and B respectively correspond to the pixels of the liquid crystal panel 21. The image data has the luminance value as the information showing the brightness of each of the pixels.

The video circuit unit 40 controls the gate driver 22 and the source driver 23 to cause the display unit 20 (liquid crystal panel 21) to display the image corresponding to the image data outputted from the image data receiving unit 30. The video circuit unit 40 has an image memory (not illustrated) which temporarily stores the image data. The image data written in the image memory is displayed on the display unit 20 as an image.

The video circuit unit 40 controls the gate driver 22 and the source driver 23 to change the transmittance in the pixels of the liquid crystal panel 21 so as to realize the luminance values of the pixels configuring the image data which is outputted from the image data receiving unit 30.

The input unit 50 is, for example, a touch panel, a press-down button group, a keyboard or the like. The input unit 50 includes a receiver (for example, an infrared receiver) which receives a command from a remote controller not illustrated loaded with buttons corresponding to them.

The color adjusting unit 60 also functions as a color adjusting unit which adjusts the color of the backlight unit 10. As a result that the color of the backlight unit 10 is adjusted, the color tone or hue of the image displayed on the display unit 20 are adjusted. The color adjusting unit 60 includes a control unit 61, a luminance value calculating unit 62, a setting menu creating unit 63 and a memory unit 65.

The control unit 61 controls the luminance value calculating unit 62, the setting menu creating unit 63 and the memory unit 65 respectively. The control unit 61 always monitors the input operation of the input unit 50. The control unit 61 controls the luminance value calculating unit 62 by the input operation of the input unit 50, and causes the luminance value calculating unit 62 to calculate the luminance value of each of the LEDs of the light source unit 11. The control unit 61 controls the light source control unit 70 to cause each of the LEDs of the light source unit 11 to emit light with the luminance value calculated by the luminance value calculating unit 62.

The luminance value calculating unit 62 functions as the luminance value calculating means for calculating the luminance value for adjusting the color tone or hue of an image. The luminance value calculating unit 62 calculates the luminance value for causing each of the LEDs of RGB of the light source unit 11 to emit light.

The setting menu creating unit 63 creates a setting menu for inputting the information showing the use environment of the liquid crystal device 1 (hereinafter, called the information of the use environment). “Setting menu” is for adjusting the color tone or hue of the image which is displayed on the display unit 20 in accordance with the use environment of the liquid crystal display device 1.

The setting menu is stored in the memory unit 65. The setting menu is properly read from the memory unit 65 by the operation of the input unit 50, and is displayed on the display unit 20. “Information of the use environment” includes the information (illumination environment) showing the color of the illumination of the room in which the liquid crystal display device 1 is installed. “Information of the use environment” sometimes further includes the information of the wall color of the room, and the information of the brightness of the light entering from outside the room, the floor color, and the kind of the floor.

As shown in FIGS. 2A to 2C, the memory unit 65 stores Tables T1 to T3 in which the information of the use environment and the coefficients indicating the ratios of the luminances of RGB (“RGB LUMINANCE RATIO COEFFICIENTS” in the drawing) are made to correspond to each other.

In Table T1, the illumination colors of a room, and a coefficient kr1 for R, a coefficient kg1 for G and a coefficient kb1 for B expressing the ratios of the luminances of RGB are shown by being brought into correspondence with one another. “ILLUMINATION COLOR” is configured by the items of, for example, “DAYLIGHT”, “WHITE LIGHT” and “BULB COLOR”, and the respective coefficients corresponding to “DAYLIGHT”, for example, are kr1=0.6, kg1=0.5, and kb1=0.5. Specifically, the ratio of the luminances of RGB corresponding to “DAYLIGHT” is R:G:B=0.6:0.5:0.5.

In Table T2, the wall color of the room, and a coefficient kr2 for R, a coefficient kg2 for G and a coefficient kb2 for B expressing the ratio of the luminances of RGB are shown by being brought into correspondence with one another. “WALL COLOR” is configured by the items of “BRIGHT”, “NORMAL” and “DARK”, and the respective coefficients corresponding to “BRIGHT” are kr2=0.6, kg2=0.5 and kb2=0.7.

In Table T3, the brightness of light entering from outside (“BRIGHTNESS OF LIGHT” in the drawing), and a coefficient kr3 for R, a coefficient kg3 for G and a coefficient kb3 for B expressing the ratio of the luminances of RGB are shown by being brought into correspondence with one another. “Brightness of light entering from outside” is classified into the items of “BRIGHT”, “NORMAL” and “DARK”. For example, the respective coefficients corresponding to “BRIGHT” are kr3=0.6, kg3=0.4 and kb3=0.5.

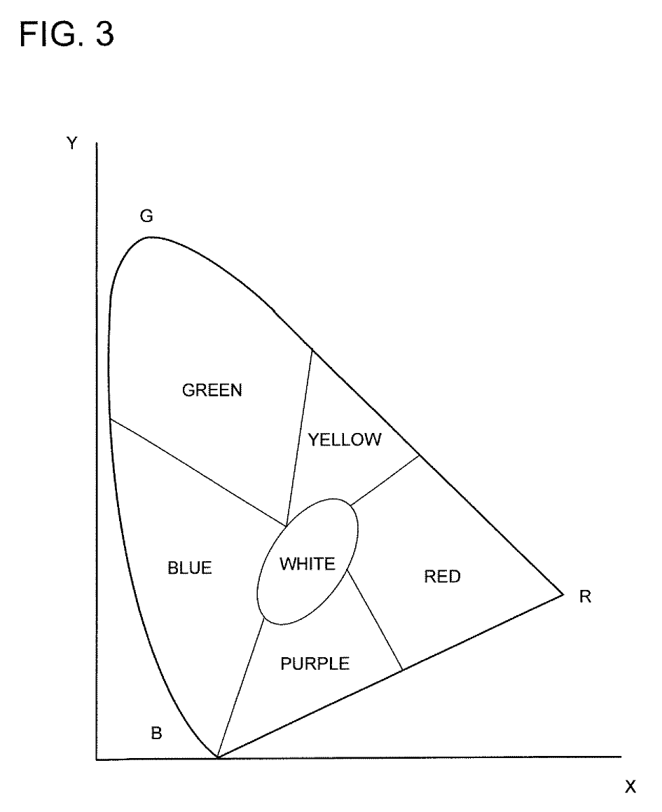

Next, by using FIG. 3, the relationship of the color of light of the backlight unit 10 and the light source unit 11 will be described. FIG. 3 is a chromaticity diagram. A chromaticity diagram includes all colors generated by mixing three colors of RGB. The color of light supplied to the display unit 20 from the backlight unit 10 becomes each color in the chromaticity diagram by changing the ratio of the luminance of each of the LEDs which the light source unit 11 has. For example, when the LED of B is not caused to emit light (namely, the luminance value of B is zero), and the LEDs of R and G are caused to emit light, the light of the backlight unit 10 becomes yellow as a result (the ratio of the luminances of the LEDs of R and G is 1:1 at this time).

Here, by changing the luminance value of the LED of R or G, the color of light (hue) can be changed. More specifically, when the luminance of the LED of G is made low with respect to the luminance of the LED of R, the color changes from yellow to orange. On the other hand, when the luminance of the LED of R is made low with respect to the luminance of the LED of G, the color changes from yellow to yellow tinged with green.

When any one of the LEDS of RGB is caused to emit light, the color tone (brightness and vividness) changes correspondingly to the luminance of the LED. More specifically, when only the LED of R is caused to emit light, the color tone changes to dark red and bright red correspondingly to the change in the luminance of the LED of R. For example, when each of the LEDs emits light based on the luminance ratio of RGB stored in Table T1, the light source unit 11 becomes purplish red, and the backlight unit 10 supplies the light of purplish red to the display unit 20.

For example, when each of the LEDs emits light based on the luminance ratio of RGB corresponding to “BRIGHT” stored in Table T2, the light source unit 11 becomes bluish purple.

When the LEDs of RGB emit light with the same luminance, the light source unit 11 is in any color from gray (black) to white (namely, a gray scale) in accordance with the luminance value of the LEDs.

Next, calculation of the luminance value of each of the LEDs by the luminance value calculating unit 62 will be described.

Each of the luminance values of the LEDs of RGB is expressed by T=T0*k1*k2*k3. T represents the luminance value of an LED. T0 is the luminance value which is the reference of the LED. k1 to k3 are coefficients. When the values of k1, k2, and k3 are one, the luminance T becomes the maximum, and the LED emits white light. The luminance value T0 which is the reference of the LED, can be stored in the memory unit 65 in advance. For the coefficients k1 to k3, the value of each coefficient of Tables T1 to T3 stored in the memory unit 65 can be used.

More specifically, a luminance value RT of the LED of R is calculated from RT=Tr0*kr1*kr2*kr3. RT represents the luminance value of the LED of R. Tr0 represents the luminance value which is the reference of the LED of R. kr1 represents the coefficient stored in Table T1. kr2 represents the coefficient stored in Table T2. kr3 represents the coefficient stored in Table T3. Similarly, a luminance value GT of the LED of G is calculated from GT=Tg0*kg1*kg2*kg3. GT represents the luminance value of the LED of G. Tg0 represents the luminance value which is the reference of the LED of G. kg1 represents the coefficient stored in Table T1. kg2 represents the coefficient stored in Table T2. kg3 represents the coefficient stored in Table T3. A luminance value BT of the LED of B is calculated from BT=Tb0*kb1*kb2*kb3. BT represents the luminance value of the LED of B. Tb0 represents the luminance value which is the reference of the LED of B. kb1 represents the coefficient stored in Table T1. kb2 represents the coefficient stored in Table T2. kb3 represents the coefficient stored in Table T3.

The luminance value of the LED may be sequentially calculated. The case of calculating the luminance value of the LED of R concretely will be described. First, the luminance value of the first LED of R is calculated from the arithmetic expression “RT1=Tr0*kr1”. The RT1 represents the luminance value of the LED of R. Tr0 represents the luminance value which is the reference of the LED of R. kr1 represents the coefficient stored in Table T1.

Thereafter, the luminance value of the second LED of R is obtained by using the arithmetic expression “RT2=RT1*kr2” (RT2 represents the luminance value of the LED of R. RT1 represents the luminance value of the first LED of R. kr2 represents the coefficient stored in Table T2).

Further, the luminance value of the third LED of R is obtained by using the arithmetic expression “RT3=RT2*kr3” (RT3 represents the luminance value of the LED of R. RT2 represents the luminance value of the second LED of R. kr3 is the coefficient stored in Table T3.).

When the LED of R is caused to emit light, the luminance value of the third LED of R is used. The liquid crystal display device 1 sometimes includes only Table T1. In this case, the LED of R emits light with the first luminance value RT1. This similarly applies to the LED of G and the LED of B.

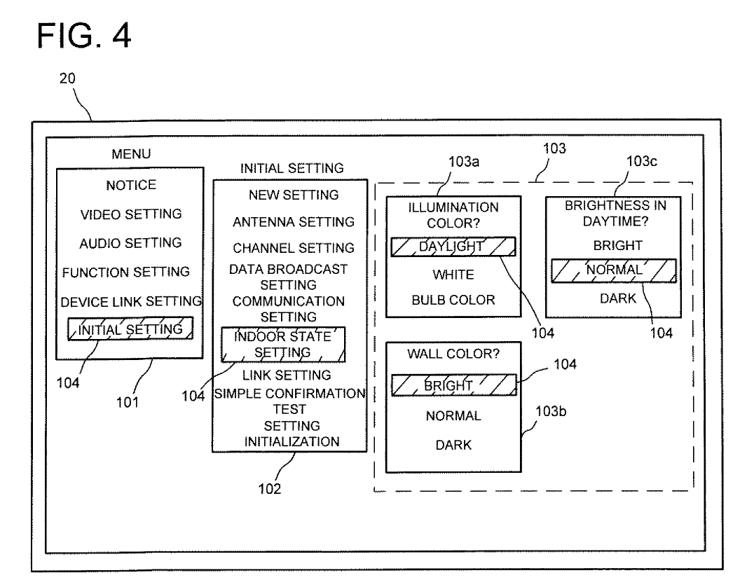

Next, the setting menu displayed on the display unit 20 will be described with reference to FIG. 4. FIG. 4 is a conceptual diagram showing the setting menu displayed on the display unit 20.

The setting menu includes a plurality of setting windows (a menu window 101, an initial setting window 102, and environment setting window 103 in FIG. 4). The priority order is set in display of each of the setting windows, for example, the menu window 101 is first displayed on the display unit 20, and a viewer selects the item “INITIAL SETTING” in the menu window 101 by using the input unit 50, whereby the initial setting window 102 is displayed.

The environment setting window 103 is displayed as a result that “ROOM STATE SETTING” which is one of the items in the initial setting window 102 is selected by the input unit 50. The environment setting window 103 includes an illumination color selecting window 103a for selecting the color of illumination, a wall color selecting window 103b for selecting the brightness of the color of a wall, and an incoming light selecting window 103c for selecting the brightness of light entering from outside the room.

On each of the selecting windows 103a to 103c, various characters such as “COLOR OF ILLUMINATION?”, “COLOR OF WALL?”, “BRIGHTNESS IN DAYTIME?” and the like are displayed so that a viewer easily grasps the present setting items.

The illumination color selecting window 103a includes the selection items of “DAYLIGHT”, “WHITE” and “BULB COLOR”.

The wall color selecting window 103b and the incoming light selecting window 103c each include the selection items of “BRIGHT”, “NORMAL” and “DARK”. “DAYLIGHT”, “BRIGHT” of the color of the wall and the like correspond to the respective items of “ILLUMINATION COLOR”, “WALL COLOR” and “LIGHT BRIGHTNESS”.

Each of the setting windows 101 to 103c includes a pointer 104 for selecting each of the items. The pointer 104 moves up and down on each of the items by being linked to the button operation of the input unit 50. A viewer presses a “decision button” not illustrated of the input unit 50 when the pointer 104 is superimposed on an optional item, and thereby, the viewer can select the item.

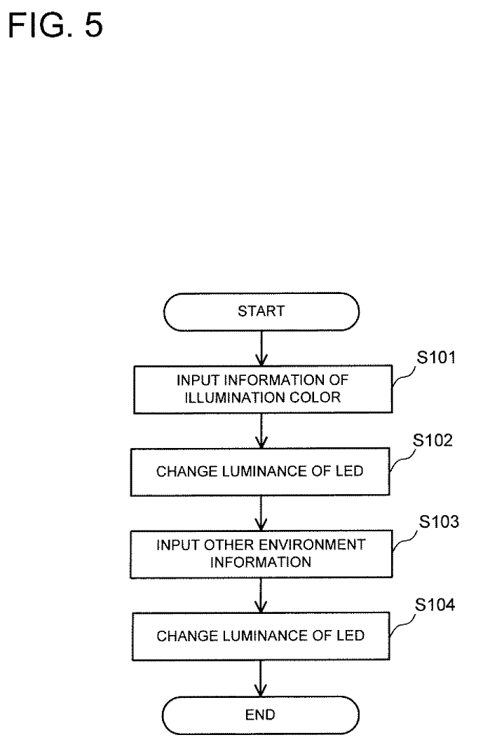

Next, a method for adjusting the color tone or hue of an image in the liquid crystal display device 1 which is configured as above will be described by using FIG. 5. FIG. 5 is a flowchart showing the method for adjusting the color tone or hue of an image.

(1) Input the information of the color of illumination (step S101)

A user presses a “setting menu display button” (not illustrated) of the input unit 50, for example, and thereby, the setting menu(see FIG. 4) is displayed on the display unit 20. Further, the user causes the environment setting window 103 to be displayed by using the input unit 50, and selects one from “DAYLIGHT”, “WHITE” and “BULB COLOR” as the color of the illumination which is one of the items.

(2) Change the luminance of the LEDs of RGB (step S102)

Based on the selection of the color of illumination, the control unit 61 refers to the reference luminance of each of the LEDs and Table T1 stored in the memory unit 65 and causes the luminance value calculating unit 62 to calculate the luminance values of the LEDs of RGB. Specifically, the control unit 61 refers to the coefficients kr1 to kb1 or the like corresponding to any of “DAYLIGHT”, “WHITE” and “BULB COLOR”, and causes the luminance value calculating unit 62 to calculate the luminance value of each of the LEDs.

The control unit 61 transmits the calculated luminance value to the light source control unit 70. The light source control unit 70 causes each of the LEDs of the light source unit 11 to emit light by using the received luminance value. Thereby, the LEDs of RGB of the light source unit 11 emit light at ratios differing from one another, and the light in the entire backlight unit 10 becomes an optional color on the chromaticity diagram as a result. Thereby, the color of the image displayed on the display unit 20 changes.

More specifically, when the color of the illumination of the room is “BULB COLOR”, the luminance of the LED of R becomes higher than the luminances of the LEDs of G and B, and therefore, the color of the backlight unit 10 increases in redness to be purplish red. When the illumination of the room is of a bulb color, the image displayed on the display unit 20 generally tends to be perceived to be pale, and therefore, the image can be prevented from being perceived to be pale by increasing the redness of the color of the backlight unit 10.

(3) Input of other environmental information and change of LED luminance (steps S103 to S104)

After selection of the color of the illumination, the user can select one from “BRIGHT”, “NORMAL” and “DARK” for each of the color of the wall and the brightness of the light entering from outside.

Based on the selection of the wall color and the brightness of the light entering from outside, the control unit 61 refers to the coefficients of Tables T2 and T3 and the like stored in the memory unit 65, and causes the luminance value calculating unit 62 to calculate the luminance values of the LEDs of RGB.

The control unit 61 transmits the calculated luminance values to the light source control unit 70. The light source control unit 70 controls the luminance of each of the LEDs of the light source unit 11 based on the received luminance values. Thereby, the luminance of each of the LEDs of R, G and B changes, and the color of the backlight unit 10 changes as a result.

Thereafter, the image data (for example, image data of a video recorded in a DVD) received by the image data receiving unit 30 is displayed on the display unit 20.

In this case, the luminance of each of the LEDs is adjusted after each brightness is decided for “wall color” and “brightness of light entering from outside”. However, the luminance of each of the LEDs is adjusted after the wall color is selected, thereafter “brightness of the light entering from outside” is decided, and thereafter, the luminance of each of the LEDs may be further adjusted (specifically, steps S103 and S104 are repeated twice).

Further, “illumination color”, “wall color” and “brightness of light entering from outside” are decided beforehand, and thereafter, the luminance value of each of the LEDs may be collectively calculated.

A user can change the color of the light of the backlight unit 10 by only selecting “illumination color”, without selecting “wall color” or “brightness of light entering from outside”. In this case, the LEDs of RGB emit light with the first luminance value (specifically, the luminance value calculated from T1=T0*k1. T1 represents the first luminance value of the LED. T0 represents the luminance value which is the reference of the LED. k1 represents the coefficient stored in Table 1). In this case, the liquid crystal display device 1 finishes the control of the change of the color of the light of the light source unit 11 after finishing the operation of step S102.

As above, according to the liquid crystal display device 1 according to this embodiment, a user only selects each of the items of the setting menu displayed on the display unit 20 by using the input unit 50, whereby the color of the light of the backlight unit 10 is changed, and as a result, the color tone or hue of the image displayed on the display unit 20 are changed.

Conventionally, correction of the color tone or hue of an image due to the color of illumination have required expert knowledge in many cases. It is not conceivable that all users have such expert knowledge, and many users have viewed images in colors unsuitable for the environments where the display devices are used.

According to the liquid crystal device 1 of the invention of the present application, the color of the light of the backlight unit 10 is changed in accordance with the use environment of the liquid crystal display device 1, and an image can be viewed in an optimal color. In other words, an image can be viewed with optimal image quality for the use environment of the display device 1.

### Second Embodiment

The liquid crystal display device 1 of the invention is not limited to the above description, and various modified examples are conceivable. For example, the video circuit unit 40 can change the color tone or hue of an image without changing the color of the light of the backlight unit 10.

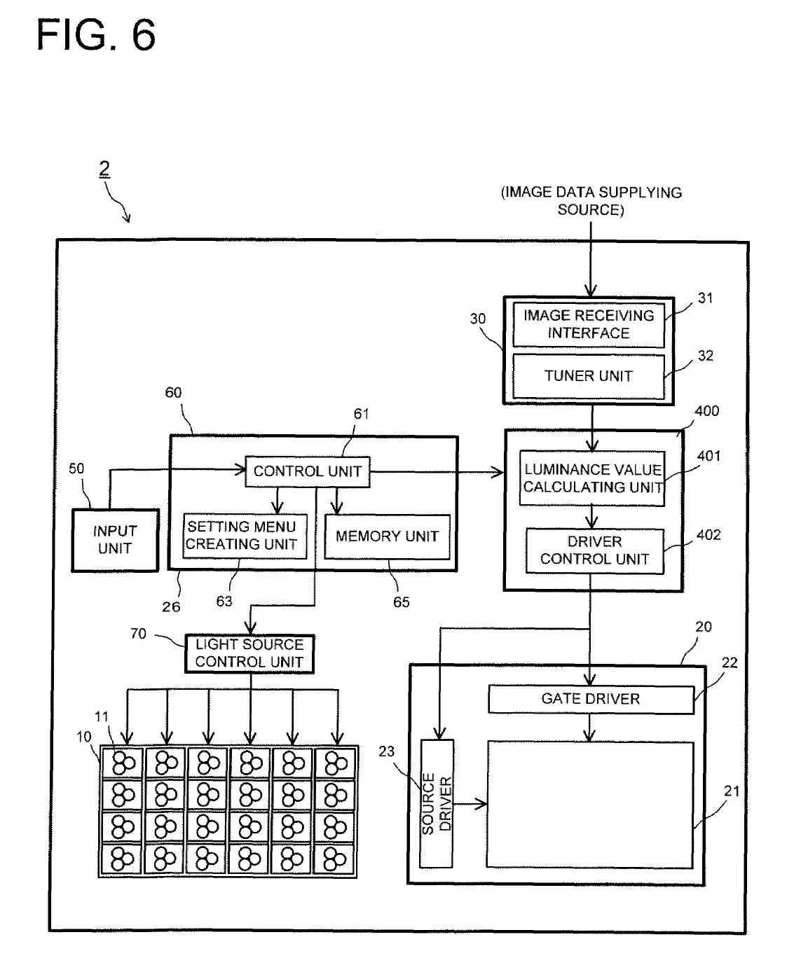

A liquid crystal display device 2 in this case will be described by being shown in FIG. 6. FIG. 6 is a block diagram showing the liquid crystal display device 2 according to a second embodiment. In the following description, the same components as in the first embodiment are assigned with the same reference numerals and characters, and the detailed explanation of them will be omitted.

The liquid crystal display device 2 of this embodiment includes the backlight unit 10, the display unit 20, the image data receiving unit 30, a video circuit unit 400, the input unit 50, the color adjusting unit 60 and the light source control unit 70.

The backlight unit 10 always supplies white light to the display unit 20.

The video circuit unit 400 functions as luminance value calculating means and a color adjusting unit. The video circuit unit 400 includes a luminance value calculating unit 401 and a driver control unit 402.

The luminance value calculating unit 401 receives image data from the image data receiving unit 30. Further, the luminance value calculating unit 401 receives the value of each of the coefficients of Tables T1 to T3 from the control unit 61 which the color adjusting unit 60 has. The luminance value calculating unit 401 calculates the luminance values of the pixels (respective luminance values of RGB) required when an image is displayed on the liquid crystal panel 21 based on the received value of each of the coefficients of Table T1 to T3 and the luminance values of the pixel data configuring the image data.

The driver control unit 402 changes the transmittance with the pixels of the liquid crystal panel 21 by controlling the gate driver 22 and the source driver 23 so as to achieve the calculated luminance values of the pixels.

The luminance value calculating unit 401 calculates the luminance values of the pixels based on the following formula.

P1=RP0*k1*k2*k3

P1 represents the luminance value calculated by the luminance value calculating unit 401. RP0 represents the luminance value of the pixel outputted by the image data receiving unit 30. k1 represents the coefficient stored in Table T1. k2 represents the coefficient stored in Table T2. k3 represents the coefficient stored in Table T3. For the coefficients k1 to k3, the values decided based on the setting menu are used as in the first embodiment.

The luminance value calculating unit 401 calculates the luminance values of the pixels of RGB based on the above arithmetic expression. The luminance value calculating unit 401 changes the transmittance with the pixels of the liquid crystal panel 21 by controlling the gate driver 22 and the source driver 23, and thereby, adjusts the color tone or hue of the image displayed on the display unit 20.

Specifically, in the liquid crystal display device 2 of this embodiment, the video circuit unit 400 calculates the luminance values of the pixels, whereby the ratio of the luminances of the pixels displayed on the display unit 20 changes in accordance by the value of each constant stored in Tables T1 to T3 without changing the color of the light of the backlight unit 10, and as a result, the color tone or hue of an image are changed. Thereby, an image can be viewed in an optimal color for the use environment of the display device 2. In other words, the image can be viewed with optimal image quality for the use environment of the display device 2.

### Other embodiments

In the above described embodiments, the color tone or hue of an image are adjusted by using any one of the color adjusting unit 60 and the video circuit unit 400, but the color tone or hue of an image can be also adjusted by using both the video circuit unit 400 and the color tone adjusting unit 60. Specifically, the color tone or hue of an image can be also adjusted by the color tone adjusting unit 60 changing the luminance value of the light source unit 11, and the video circuit unit 400 further calculating the luminance value of the image which is displayed on the display unit 20.

Further, in the above described embodiments, calculation is performed by referring to the setting menu for the luminance values of the LEDs of RGB, but in addition to this, the liquid crystal display device 1 or the liquid crystal display device 2 may include the function of optionally resetting the luminance values of the LEDs of RGB by a user. More specifically, after “illumination color” or the like of the setting menu is selected, and the respective luminance values of the LEDs of RGB are calculated, the calculated luminance values are increased and decreased. At this time, for example, an indicator or the like is displayed on the display unit 20 so that a viewer can visually confirm an increase and decrease in the luminance values. A viewer changes the respective luminance values of the LEDs of RGB by a button operation (for example, a “+” button and a “−” button) of the input unit 50 while confirming the indicator.

Further, the liquid crystal display device 1 or the liquid crystal display device 2 can include a brightness sensor in a predetermined location of the display unit 20. The brightness sensor is controlled by the control unit 61. The light amount of the periphery (any one of a front, side and back) of the liquid crystal display device 1 is measured by the brightness sensor, and digitized. In this case, as the use environment, the information of “window position” for the liquid crystal display device 1 or the liquid crystal display device 2 is added to “room illumination color”, “room wall color” and “brightness of the light entering from outside the room”. “window position” is “front”, “side” or “back” with respect to the position where the liquid crystal display device 1 is disposed.

The memory unit 65 includes Table T4 in which the information of “window position”, and the coefficients expressing the ratio of the luminances of the LEDs of RGB corresponding to the information are expressed by being brought into correspondence with one another, and the setting menu further includes the items for deciding the information of “window position”. The coefficients stored in Table T4 can be defined by the light amount measured by the brightness sensor.

A user refers to the setting menu, and decides “window position” by using the input unit 50, whereby operation and non-operation of the brightness sensor corresponding to the “window position” can be controlled.

Further, as the setting menu of the use environment, “floor color” and “floor kind” of the room where the liquid crystal display device 1 or the liquid crystal display device 2 is disposed are added, so that finer adjustment of the color tone or hue of an image can be performed. In this case, the memory unit 65 includes Table T5 and Table T6 in which the information of “floor color” and “floor kind”, and the coefficients expressing the ratios of the luminances of the LEDs of RGB corresponding to these kinds of information are expressed by being brought into correspondence with one another.

As described above, by setting the parameter corresponding to the use environment, a user can easily enjoy videos with optimal image quality for the indoor state without needing expert knowledge or adjustment.

### Other Embodiments

The embodiment of the present can be expanded and modified without being limited to the above described embodiments, and expanded and modified embodiments are included in the technical range of the present invention.

What is claimed is:

1. A display device, comprising:
an image data receiving unit receiving image data;
a display unit displaying an image based on the image data received by the image data receiving unit;
a light source supplying light to the display unit;
an input unit inputting information showing a use environment at a time of viewing an image displayed on the display unit;
a luminance value calculating unit calculating a value for adjusting a color tone or hue of the light source or the image based on the inputted information; and
a color adjusting unit adjusting the color tone or hue of the light source or the image based on the calculated value.

2. The display device according to claim 1,
wherein the information showing the use environment inputted by the input unit includes any one of an illumination color, brightness of a wall color of a room, brightness of light entering from outside, a floor color and a window position.

3. The display device according to claim 1,
wherein the color adjusting unit adjusts a ratio of colors of light of the light source to adjust the color tone or hue of the image, based on the inputted information showing the use environment.

4. The display device according to claim 1,
wherein the image data has information showing luminance values, and
the color adjusting unit corrects the information showing each of the luminance values based on the inputted information showing an illumination environment and thereby, adjusts the color tone or hue of the image.

5. The display device according to claim 1,
wherein the image data receiving unit further comprises a tuner for receiving a radio wave including the image data.

6. A method for adjusting a color tone or hue of an image that is a method for adjusting a color tone or hue of an image in a display device including a display unit displaying the image and a light source supplying light to the display unit, comprising:
inputting information showing a use environment at a time of viewing an image displayed on the display unit;
calculating a value indicating a color tone or hue of the light source or the image based on the inputted information;
receiving the image data;
adjusting the color tone or hue of the light source or the image based on the calculated value; and
displaying an image based on the received image data.

7. The method for adjusting a color tone or hue of an image according to claim 6,
wherein the inputted information showing the use environment includes any one of an illumination color, brightness of a wall color of a room, brightness of light entering from outside, a floor color and a window position.

8. The method for adjusting a color tone or hue of an image according to claim 6,
wherein in the adjusting the color tone or hue of the image, a ratio of colors of light of the light source is adjusted to adjust the color tone or hue of the image, based on the inputted information showing the use environment.

9. The method for adjusting a color tone or hue of an image according to claim 6,
wherein the image data has the information showing luminance values, and
in the adjusting the color, the information showing each of the luminance values is corrected based on the inputted information showing an illumination environment, and thereby, the color tone or hue of the image are adjusted.
